(19) United States
(12) Patent Application Publication
(10) Pub. No.: US 2013/0004762 A1
(43) Pub. Date: Jan. 3, 2013

(54) ARTICLES COMPRISING A GLASS-FLEXIBLE STAINLESS STEEL COMPOSITE LAYER

(75) Inventors: SALAH BOUSSAAD, Wilmington, DE (US); DAMIEN FRANCIS REARDON, Wilmington, DE (US)

(73) Assignee: E. I. DU PONT DE NEMOURS AND COMPANY, Wilmington, DE (US)

(21) Appl. No.: 13/544,904

(22) Filed: Jul. 9, 2012

Related U.S. Application Data
(63) Continuation-in-part of application No. 12/881,235, filed on Sep. 14, 2010, now abandoned.

(51) Int. Cl. B32B 15/04; B32B 17/06

(52) U.S. Cl. 428/332; 428/433

(57) ABSTRACT

The present disclosure relates to a method of manufacturing of a glass coated metal product. This invention also relates to a coated metallic substrate material that is suitable for manufacturing flexible solar cells and other articles in which a passivated stainless steel surface is desirable.

This application is a Continuation-In-Part of application Ser. No. 12/881,235 filed Sep. 14, 2010.

### FIELD OF THE INVENTION

The present disclosure relates to a method of manufacturing a glass coated metal product. This invention also relates to a coated metallic substrate material that is suitable for manufacturing flexible solar cells and other articles in which a passivated stainless steel surface is desirable.

### BACKGROUND

Photovoltaic cells are made by depositing various layers of materials on a substrate. The substrate can be rigid (e.g., glass or a silicon wafer) or flexible (e.g., a metal or polymer sheet).

The most common substrate material used in the manufacture of thin-film Cu(In,Ga)Se₂ (CIGS) solar cells is soda lime glass. Soda lime glass contributes to the efficiency of the solar cell, due to the diffusion of an alkali metal (primarily sodium) from the glass into the CIGS layer. However, batch production of CIGS on glass substrates is expensive and glass is typically too rigid to be adapted to a roll-to-roll process. The disadvantages of using common glass substrates for the photovoltaic cells have motivated the search for substrates that are flexible, tolerant of the high temperatures used to create the photoactive layers, inexpensive and suitable for use in roll-to-roll processes.

Several materials have been tested as substrate materials for flexible CIGS solar cells, including polymers such as polyimide and metals such as molybdenum, aluminum, stainless steel and titanium foils. The substrate should be tolerant of temperatures up to 800° C. and reducing atmospheres. The substrate must also be electrically insulated from the back contact to facilitate production of CIGS modules with integrated series connections. It is desirable for the coefficient of thermal expansion (CTE) of the substrate material to be as close as possible to the CTE of the electrical insulating material to avoid cracking or delamination of the insulating material from the substrate and curling of the substrate.

There is also interest in developing CZTS-Se based solar cells, analogous to CIGS solar cells except that CIGS is replaced by CZTS-Se, where “CZTS-Se” encompass all possible combinations of Cu₂ZnSn(S,Se)₄, including Cu₂ZnSnS₄, Cu₂ZnSnSe₄, and Cu₂ZnSnSₓSe₄₋ₓ, where 0≦x≦4.

Since polymers are generally not thermally stable above 500° C., coated metal substrates have been desirable since temperatures of above 500° C. are routinely achieved in many applications, including photovoltaic cells.

To form an electrically insulating layer on the metal substrate, it is known to deposit SiOₓ or SiO₂ onto metal strips in batch-type deposition processes.

It is also known to coat a metallic base with a first coat of an alkali silicate, optionally containing alumina particles. A second coat of silicone can be applied onto the first coat of an alkali silicate.

In another approach, a stainless steel plate is contacted with a solution of a metal alkoxide, an organoalkoxysilane, water, and thickeners such as alkoxy silane in an organic solvent, then dried and calcined.

A method for producing a substrate for solar batteries has also been disclosed in which a first insulating layer is formed on a metal plate (e.g., a stainless steel plate). Then the surface of the metal plate exposed by pinholes in the first insulating layer is oxidized by heating the metal plate in air. A second insulating layer is then applied over the first insulating layer.

A coated steel substrate useful as a substrate for flexible CIGS solar cells has been disclosed that comprises a stainless steel strip coated with a sodium-doped alumina layer onto which an electrically conducting layer of molybdenum has been deposited.

A process for forming an electrically insulating layer of aluminum oxide on ferritic stainless steel has been disclosed. The alumina-coated stainless steel sheet was used as a substrate for an amorphous silicon solar battery manufactured by plasma chemical vapor deposition (P-CVD) on the oxide film.

In co-pending U.S. application Ser. No. 12/832,315, is disclosed a steel substrate having a coating of glass, and having disposed between the glass and the steel layers a layer of alumina.

There remains a need for process to produce a substrate that has the flexibility of a metal, the surface properties of glass, and can be used in a roll-to-roll process for the manufacture of CIGS cells, without the need for a interlayer coating between the glass coating and the metal substrate.

### SUMMARY

In one aspect the present invention is a multi-layer article comprising:
a) a stainless steel substrate comprising 1 to 10 wt % aluminum; and
b) a glass layer disposed directly on at least a portion of a surface of the metal substrate, wherein there are no intervening layers disposed between the glass layer and the surface of the metal substrate, and wherein the glass layer comprises SiO₂, Al₂O₃, Na₂O, and B₂O₃ and optionally an oxide selected from the group consisting of Li₂O, BeO, BaO, MgO, K₂O, CaO, MnO, NiO, SrO, FeO, Fe₂O₃, CuO, Cu₂O, CoO, ZnO, PbO, GeO₂, SnO₂, Sb₂O₃, Bi₂O₃, or any oxide of a lanthanide metal.

### DETAILED DESCRIPTION

In one embodiment, the present invention is a process for depositing and/or forming a glass layer on the surface of a flexible stainless steel substrate. It can be desirable to impart glass-like properties to the surface of flexible materials in order to overcome at least some disadvantages of using common glass substrates in, for example, photovoltaic cells.

Flexibility in a metal substrate can be dependent on the intrinsic properties of the specific metal, as well as on the bulk properties such as thickness. Extrinsic conditions, such as temperature for example, can affect flexibility. For the purposes of the present invention, flexibility can be loosely described as the extent to which the substrate will allow utilization of roll-to-roll processes.

Due to the process temperatures required for firing the glass precursor coating and forming a glass layer on the flexible substrate, a suitable substrate must be able to withstand processing temperatures of greater than 250° C. up to about 800° C.

One aspect of this invention is a process comprising:
a) depositing a glass precursor on at least a portion of a surface of a stainless steel substrate; and
b) heating the glass precursor to form a glass layer on at least a portion of the stainless steel substrate, wherein the glass layer comprises SiO₂, Al₂O₃, Na₂O, and B₂O₃, and optionally an oxide selected from the group consisting of Li₂O, BeO, BaO, MgO, K₂O, CaO, MnO, NiO, SrO, FeO, Fe₂O₃, CuO, Cu₂O, CoO, ZnO, PbO, GeO₂, SnO₂, Sb₂O₃, Bi₂O₃, any oxide of a lanthanide metal, or a mixture of any of these.

This process is useful in order to passivate a surface of the stainless steel substrate. Passivation is desirable to insulate or isolate one component, for example the stainless steel layer, of an article or device from chemical or physical interaction with another component, for example a CIGS layer, where that interaction can be undesirable. For example, passivation may protect the surface of the substrate from chemical attack. The glass layer may serve as a thermal and/or electrical insulating layer, or also as an ion barrier, preventing detrimental doping of CIGS from iron, chromium, vanadium, nickel, titanium, phosphorus, manganese, molybdenum, niobium (or columbium) upon thermal processing of solar cells at elevated temperatures (ion migration prevention at 600° C. has been characterized by ESCA). An additional desirable property the glass passivation layer offers is leveling of the stainless steel surface to minimize shunting of the solar cell (planarization Ra<20 nm can be achieved and have been measured).

This process can be conducted batch-wise or as a continuous process, for example, in a roll-to-roll process.

### Stainless Steel Substrate

Suitable stainless steel substrates can be in the form of sheets, foils or other shapes. Sheets and foils are preferred for roll-to-roll processes. Suitable stainless steel typically comprises: 13-22 wt % chromium; 1.0-10 wt % aluminum; less than 2.1 wt % manganese; less than 1.1 wt % silicon; less than 0.13 wt % carbon; less than 10.6 wt % nickel; less than 3.6 wt % copper; less than 2 wt % titanium; less than 0.6 wt % molybdenum; less than 0.15 wt % nitrogen; less than 0.05 wt % phosphorus; less than 0.04 wt % sulfur; and less than 0.04 wt % niobium, wherein the balance is iron.

In some embodiments, the stainless steel comprises: about 13 wt % chromium; 3.0-3.95 wt % aluminum; less than 1.4 wt % titanium; about 0.35 wt % manganese; about 0.3 wt % silicon; and about 0.025 wt % carbon, wherein the balance is iron.

In some embodiments, the stainless steel comprises: about 22 wt % chromium and about 5.8 wt % aluminum, wherein the balance is iron.

In still another embodiment, certain grades of stainless steel can be suitable wherein essentially no aluminum is included in the stainless steel. For example, 430 grade stainless steel and 304 grade stainless steel can be suitable for use herein, but do not substantially include aluminum as a component of the stainless steel.

For the purposes of the present invention, quantities of any component that are so small that they cannot be measured quantitatively by known and/or conventional methods are not considered to be within the scope of the present invention and, therefore, when only an upper compositional range limit is provided it should be understood to mean that a measureable lower limit is within the scope of the invention.

### Glass Precursor Layer

In one aspect of this invention, the substrate is coated with a glass precursor layer, followed by steps of drying and firing the glass precursor layer to form a glass layer on the stainless steel substrate. As described below, the thickness of the glass layer can be increased by carrying out multiple cycles of coating-and-drying before firing, or by carrying out several cycles of coating-drying-and-firing.

The glass layer is formed by coating the surface of the stainless steel substrate, in whole or in part, with a glass precursor composition. The precursor composition can comprise: (1) a form of silicon that is soluble in at least one solvent; (2) an aluminum compound; (3) a boron-containing compound; (4) a sodium salt and, optionally (5) a potassium salt.

A soluble form of silicon can be, for example, silicon tetraacetate, silicon tetrapropionate, bis(acetylacetonato) bis(acetato) silicon, bis(2-methoxyethoxy) bis (acetato) silicon, bis(acetylacetonato) bis(ethoxy) silicon, tetramethylorthosilicate, tetraethylorthosilicate, tetraisopropylorthosilicate, or mixtures thereof).

An aluminum compound can be, for example: tris(acetylacetonato) aluminum, aluminum methoxide, aluminum ethoxide, aluminum isopropoxide, aluminum n-propoxide, or mixtures thereof) is added as well as a trialkylborate (for example, trimethylborate, triethylborate, tripropylborate, trimethoxyboroxine, or mixtures thereof.

A precursor for sodium oxide can be, for example, sodium acetate, sodium propionate, sodium silicate, sodium alkoxides, sodium borate, sodium tetraphenyl borate, or mixtures thereof.

The optional potassium salt can be, for example, potassium acetate, potassium propionate, potassium methoxide, potassium ethoxide, potassium isopropoxide, or mixtures thereof.

To form the glass precursor composition, the soluble silicon can be dissolved in a solvent such as, for example: (1) a C1-C10 alcohol (for example methanol, ethanol, 1-propanol, 2-propanol, 1-butanol, 2-butanol, isomers of 1-butanol, 1-pentanol, 2-pentanol, 3-pentanol, isomers of 1-pentanol, 1-hexanol, 2-hexanol, 3-hexanol, isomers of 1-hexanol, 1-heptanol, isomers of 1-heptanol, or mixtures thereof); (2) an acid (for example, acetic acid, propionic acid, hydrochloric acid, nitric acid, sulfuric acid, or mixtures thereof) and (3) water to obtain a solution of dissolved silicon solution. Water can be included in an amount of from 0 to 4 mole equivalents, with respect to silicon. Minimal amounts of the solvent can be used, with the caveat that the amount should be sufficient and effective to form a solution of the components.

The sodium salt can be dissolved in the same C1-C10 alcohol used to prepare the initial silicon solution, and added to the silicon solution. In some embodiments, the glass precursor formulation is filtered prior to coating the stainless steel substrate. In some embodiments, the composition of the glass precursors in the formulation is in an element ratio of about 100 (Si) to 45 (B) to 26 (Na) to 3 (Al).

In one embodiment, the precursor composition can be prepared by dissolving a silicon oxide precursor (for example, tetraethylorthosilicate) in a minimum amount of 1-butanol, or a 1:1 mixture of 1-butanol and acetic acid, and stirring. To this solution, two mole equivalents of water are added and the solution is refluxed for one hour. An aluminum oxide precursor (for example, tris(acetylacetonato)aluminum), a boron oxide precursor (for example, triethyl borate) and a sodium oxide precursor (for example, sodium tetraphenylborate) in 1-butanol, are added. Once the precursors are dissolved, more solvent is added to obtain the desired concentration.

The glass layer can optionally include an oxide of lithium, magnesium, potassium, calcium, barium, lead, germanium, tin, antimony, bismuth or any lanthanide. Suitable precursors for Li₂O, MgO, BaO, K₂O, CaO, PbO, GeO₂, SnO₂, Sb₂O₃, Bi₂O₃ or any oxide of a lanthanide metal can include the respective acetates, for example: potassium acetate, calcium acetate, lead acetate, germanium acetate, tin acetate, antimony acetate, and bismuth acetate. Other oxide precursors can be used, as may be known to one of ordinary skill in the art.

Silicon alkoxides (for example, a silicon tetraalkylorthosilicate) and aluminum alkoxides (for example, aluminum isopropoxide) can also be used in the preparation of the glass precursor compositions.

Optionally, borosilicate glass nanoparticles can be added to the formulation.

Depositing a coating of the glass precursor composition onto the stainless steel substrate can be carried out by any known and/or conventional means, including bar-coating, spray-coating, dip-coating, microgravure coating, or slot-die coating. One of ordinary skill in the art would appreciate the benefits and/or disadvantages of any of these conventional coating means, and could choose an appropriate coating method based on the particulars of the process parameters under consideration.

After coating the glass precursor composition onto the stainless steel substrate, the precursor is typically dried in air at 100 to 150° C. to remove solvent. In some embodiments, the dried glass precursor layer is then fired in air or an oxygen-containing atmosphere at 250 to 800° C. to convert the glass precursor layer to a fired glass layer. By “firing” it is meant that the glass precursor layer is heated above the decomposition temperature of the precursors in an oxidizing atmosphere to:
1) remove any organic ligands used to solubilize the glass precursors in the coatable solution and;
2) oxidize silicon, aluminum, boron and sodium components of the solution to their respective oxide form and;
3) form a thin, dense glass film on the substrate.
   It can be desirable to increase the thickness of the fired glass layer by carrying out additional cycles of (1) depositing the glass precursor on surface of the substrate (coating) and (2) drying prior to firing.

The cycle of (1) coating followed by (2) drying can be repeated numerous times, depending on the thickness of the glass layer that is desirable, and the number of repetitions that are needed to obtain the desired thickness. Typically the desired thickness can be obtained with 2-5 repetitions of the coating/drying cycle.

The thickness of the fired glass layer can be from about 10 nm to several micrometers in thickness. In certain embodiments, the thickness of the glass fired layer can be in the range of from about 10 nm to several microns in thickness. In some uses—for example when used in a photovoltaic cell—it can be desirable to increase the flexibility of the fired glass layer by reducing its thickness to within the range of from about 1 nm to about several microns. However, the desired thickness for flexibility will depend on the composition.

In some embodiments, the steps of (1) coating, (2) drying, and (3) firing are repeated 2 or more times. This can also increase the total thickness of the fired glass layer. Multiple intermediate firing steps facilitate removal of any carbon that might be present in the glass precursor components, and therefore multiple firing steps can be preferred.

In some embodiments, water is added to the precursor mixture prior to the coating step. This increases the viscosity of the glass precursor composition and facilitates the formation of glass layers of 50 nm to 2 microns thickness in one coating and drying cycle.

Both the firing step(s) and drying step(s) are typically conducted in air to ensure complete oxidation of the glass precursors. The presence of elemental carbon, carbonate intermediates or reduced metal oxides in the glass layer may lower the dielectric strength of the insulating layer.

After firing, the glass layer typically comprises: greater than 70 wt % silica; less than 10 wt % alumina; 5-15 wt % of a boron oxide; and less than 10 wt % of oxides of sodium and/or potassium. In one embodiment, the fired glass layer comprises: about 81 wt % SiO₂, about 13 wt % B₂O₃, from about 1% up to about 4 wt % Na₂O, and about 2 wt % Al₂O₃.

In some embodiments, the glass precursor compositions are selected to provide coefficients of linear thermal expansion (CTE) of the glass layers to be close to those of the Mo and CIGS (or CZTS-Se) layers to reduce stress on the Mo and CIGS (or CZTS-Se) layers and to reduce substrate curling. In some embodiments, the CTE of the borosilicate glass is about 3.25×10⁻⁶/° C. to provide a good match to the CTE of the Mo layer (about 4.8×10⁻⁶/° C.) and the CIGS layer (about 9×10⁻⁶/° C.).

One aspect of this invention is a multi-layer article comprising:
a) a stainless steel substrate comprising up to 10 wt % aluminum;
b) a glass layer disposed directly on at least a portion of the stainless steel, wherein the glass layer comprises SiO₂, Al₂O₃, Na₂O, B₂O₃, and optionally an oxide selected from the group consisting of Li₂O, BeO, BaO, MgO, K₂O, CaO, MnO, NiO, SrO, FeO, Fe₂O₃, CuO, Cu₂O, CoO, ZnO, PbO, GeO₂, SnO₂, Sb₂O₃, Bi₂O₃, and any oxide of a lanthanide metal.

The stainless steel substrate and glass layer are as described above.

This multilayer article can be used as the substrate for the manufacture of electronic devices, such as for example, organic light emitting diode display applications, white light organic light emitting diode applications, photovoltaic applications. Such multilayer articles can also be used in medical devices such as heart valves.

In some embodiments, the multilayer article further comprises:
c) a conductive layer disposed on at least a portion of the glass layer.

In some embodiments, the multilayer article further comprises:
d) a photoactive layer disposed on the conductive layer;
e) a CdS layer disposed on the photoactive layer; and
f) a transparent conductive oxide disposed on the CdS layer.

Such multilayer articles can be used in photovoltaic cells, for example.

Suitable conductive layers comprise materials selected from the group consisting of metals, oxide-doped metals, metal oxides, organic conductors, and combinations thereof. A conductive metal layer can be deposited onto the glass layer through a vapor deposition process or electrolysis or electroplating. Suitable metals include Mo, Ni, Cu, Ag, Au, Rh, Pd and Pt. The conductive metal layer is typically 200 nm −1 micron thick. In one embodiment, the conductive material is molybdenum oxide-doped molybdenum.

In some embodiments, the multilayer article comprises organic functional layers, e.g., organic conductors such as polyaniline and polythiophene. In such embodiments, the multilayer article is generally not heated above 450° C., or 400° C., or 350° C., or 300° C., or 250° C., or 200° C., or 150° C., or 100° C. after the organic functional layer has been deposited.

Suitable photoactive layers include CIS (cadmium-indium-selenide), CIGS, and CZTS-Se. The CIGS and CIS layers can be formed by evaporating or sputtering copper, indium and optionally gallium sequentially or simultaneously, then reacting the resulting film with selenium vapor. Alternatively, a suspension of metal oxide particles in an ink can be deposited on the conductive layer using a wide variety of printing methods, including screen printing and ink jet printing. This produces a porous film, which is then densified and reduced in a thermal process to form the CIGS or CIS layer. Any known or conventional process can be used to form the CIGS or CIS layers.

CZTS-Se thin films can be made by several methods, including thermal evaporation, sputtering, hybrid sputtering, pulsed laser deposition, electron beam evaporation, photochemical deposition, and electrochemical deposition. CZTS thin-films can also be made by the spray pyrolysis of a solution containing metal salts, typically CuCl, ZnCl₂, and SnCl₄, using thiourea as the sulfur source.

The CdS layer can be deposited by chemical bath deposition, for example. Other means that are known and/or conventional can be used.

A suitable transparent conductive oxide layer, such as doped zinc oxide or indium tin oxide, can be deposited onto the CdS layer by sputtering or pulsed layer deposition, for example. Other methods that are known and/or are conventional to one of ordinary skill in the art can be used.

### EXAMPLES

### General

### Comparative Examples A, B, and C:

A 50.8 micrometer thick stainless steel foil (Ohmaloy® 30, 2-3 wt % aluminum, ATI Allegheny Ludlum) was annealed at 1000° C. in air for 15 hr to provide a coating of alumina on the surface of the stainless steel foil. The foil was then diced to size and argon plasma-cleaned (A.G. Services PE-PECVD System 1000) for 30 sec under the following conditions:
power=24.3 W
pressure=100.0 mTorr
throttle pressure=200.0 mTorr
argon gas flow=10.0 sccm

### Preparation of a Precursor Composition Containing 0.75 M [Si]:

Tetraethylorthosilicate (3.9042 g, 18.74 mmol) was dissolved in 1-butanol (5.00 ml) and 5 ml of acetic acid containing 0.6725 ml of deionized water. The solution was refluxed for 1 h. To this solution, was added triethylborate (0.5247 g, 3.59 mmol) and tris(acetylacetonato) aluminum (0.1768 g, 0.55 mmol). Separately, a sodium tetraphenylborate (1.6553 g; 4.84 mmol) solution in 1-butanol (5 ml) was prepared and mixed with the silicon, aluminum, boron precursor 1-butanol solution. The solution was stirred and 1-butanol was added until a total volume of 25.00 ml was achieved. The glass precursor composition was filtered through a 2 micron filter prior to coating the stainless steel substrate.

### Rod-Coating:

The substrates were rod-coated using a #20 bar on a Cheminstrument® motorized drawdown coater at room temperature in a clean room environment (class 100). The coated substrate was then dried at 150° C. for 1 min to form a dried glass precursor layer on the annealed stainless steel substrate. This procedure was used one or more times in each of the examples described below.

### Firing:

After drying, the coated substrates were fired to 600° C. for 30 min at a ramp rate of 8° C./s using a modified Leyboldt L560 vacuum chamber outfitted with cooled quartz lamp heaters above and below the coated substrate, with an air bleed of 20 sccm (total pressure 1 mTorr). Out-gassing was monitored using a residual gas analyzer. This procedure was used one or more times in each of the examples described below.

### Determination of Dielectric Strength:

Breakdown voltage was measured with a Vitrek 944i dielectric analyzer (San Diego, Calif.). The sample was sandwiched between 2 electrodes, a fixed stainless steel rod as cathode (6.35 mm diameter and 12.7 mm long) and a vertically sliding stainless steel rod as anode (6.35 mm diameter and 100 mm long). The mass of the sliding electrode (32.2 g) produced enough pressure so the anode and cathode form good electrical contact with the sample. The voltage was ramped at 100 V/s to 250 V and kept constant for 30 sec to determine the breakdown voltage and the sustained time. The thickness was measured using a digital linear drop gauge from ONO SOKKI, model EG-225. Dielectric strength can be calculated as the breakdown voltage per unit of thickness.

### EXAMPLE 1

### One Firing of Multiple Layers

The filtered glass precursor composition described above (0.1 ml) was rod-coated onto an annealed, plasma-cleaned stainless steel substrate and dried, as described above.

The drawdown coating and drying cycle was repeated five times The substrate was then fired, as described above.

Breakdown voltage was found to be 520-600 V DC at 10 randomly selected locations.

After firing, a 200 nm Mo coating was deposited on the fired glass layer via sputter vapor deposition.

### EXAMPLE 2

### Deposition of a Single Layer which is then Fired, Followed by Deposition of Subsequent Layers which are then Fired

The filtered glass precursor composition (0.1 ml) was rod-coated onto an annealed, plasma-cleaned stainless steel substrate and dried, as described above.

This layer was then fired as described above.

The drawdown coating and drying cycle was repeated under the same conditions five times. The coated substrate was fired a second time, and then a 200 nm Mo layer was deposited on the fired glass layer via sputter vapor deposition.

### EXAMPLE 3

### Multiple Firing Process

The filtered glass precursor composition (0.1 ml) was rod-coated onto an annealed, plasma-cleaned stainless steel substrate and dried, as described above.

This layer was then fired as described above.

The cycle of coating, drying and firing steps was repeated five times.

A 200 nm Mo top electrode was deposited onto the fired glass layer via sputter vapor deposition.

### EXAMPLE 4

### Borosilicate Glass Coating Directly on Stainless Steel

This example demonstrates that a coating of a borosilicate glass directly onto a stainless steel substrate can lead to lower breakdown voltages.

A 50.8 micrometer thick stainless steel foil (stainless steel 430, ATI Allegheny Ludlum) was diced to size and argon plasma-cleaned (A.G. Services PE-PECVD System 1000) for 30 sec under the following conditions:
power=24.3 W
pressure=100.0 mTorr
throttle pressure=200.0 mTorr
argon gas flow=10.0 sccm

The filtered glass precursor formulation (0.1 ml) was rod-coated onto a plasma-cleaned stainless steel substrate and dried.

This layer was then fired as described above.

The cycle of coating, drying and firing steps was repeated five times.

A 200 nm Mo top electrode was deposited onto the fired glass layer via sputter vapor deposition.

What is claimed is:

1. A multi-layer article comprising:
a) a stainless steel substrate comprising up to 10 wt % aluminum, wherein the stainless steel substrate is in the form of a sheet;
b) a borosilicate glass layer disposed directly on at least a portion of a surface of the stainless steel substrate, wherein there are no intervening layers disposed between the glass layer and the surface of the stainless steel substrate, wherein the glass layer comprises SiO₂, Al₂O₃, Na₂O, and B₂O₃, and optionally an oxide selected from the group consisting of Li₂O, BeO, MgO, BaO, K₂O, CaO, MnO, NiO, SrO, FeO, Fe₂O₃, CuO, Cu₂O, CoO, ZnO, PbO, GeO₂, SnO₂, Sb₂O₃, Bi₂O₃, an oxide of any lanthanide metal, or mixtures of any of these, wherein the glass layer forms a glass film on the stainless steel, and wherein the glass layer has a coefficient of linear thermal expansion of about 3.25×10⁻⁶/° C.

2. The multi-layer article of claim 1, further comprising: c) a conductive layer disposed on at least a portion of the glass layer.

3. The multi-layer article of claim 2, wherein the conductive layer comprises material selected from the group consisting of metals, oxide-doped metals, metal oxides, organic conductors, and combinations thereof.

4. The multi-layer article of claim 3, wherein the conductive layer comprises molybdenum.

5. The multilayer article of claim 2, further comprising:
d) a photoactive layer disposed on the conductive layer;
e) a CdS layer disposed on the photoactive layer; and
f) a transparent conductive oxide disposed on the CdS layer.

6. The multilayer article of claim 5, wherein the photoactive layer comprises CIGS, CIS or CZTS-Se.

7. The multilayer article of claim 5, wherein the transparent conductive oxide is selected from the group consisting of doped zinc oxide and indium tin oxide.

8. The multilayer article of claim 1, wherein the glass layer comprises greater than 70 weight percent silica, less than 10 weight percent alumina, 5-15 weight percent of a boron oxide, and less than 10 weight percent of oxides of sodium and/or potassium.

9. The multilayer article of claim 1, wherein the glass layer comprises about 81 weight percent SiO₂, about 13 weight percent B₂O₃, from about 1 weight percent up to about 4 weight percent Na₂O, and about 2 weight percent Al₂O₃.

10. The multilayer article of claim 9, wherein the glass layer further comprises an oxide of lithium.

11. The multilayer article of claim 1, wherein the glass layer has a thickness from about 1 nm to several microns.
